(19) United States
(12) Patent Application Publication
(10) Pub. No.: US 2002/0174148 A1
(43) Pub. Date: Nov. 21, 2002

(54) System and method for formatting international shipping addresses

(75) Inventor: Benjamin Seidman, Longmont, CO (US)

Correspondence Address: PHILMORE H. COLBURN II, CANTOR COLBURN LLP, 55 GRIFFIN ROAD SOUTH, BLOOMFIELD, CT, 06002, US

(73) Assignee: INTERNATIONAL BUSINESS MACHINES CORPORATION, ARMONK, NY

(21) Appl. No.: 09/861,153

(22) Filed: May 18, 2001

(51) Int. Cl. G06F 15/00

(52) U.S. Cl. 707/517

(57) ABSTRACT

An exemplary embodiment of the present invention is a method for formatting international shipping addresses. The method includes receiving a parsed address from a system user and then looking up the parsed address in an index table. A corresponding address format is retrieved from the index table and then the parsed address is reformatted to comply with the retrieved address format. Additional embodiments include a system and storage medium for formatting international shipping addresses.

### FIELD OF THE INVENTION

This present invention relates generally to formatting address labels. More particularly, the present invention relates to a method and system for reformatting parsed address labels based on country formats.

### BACKGROUND OF THE INVENTION

Due in part to the widespread use of the Internet to sell products, modern businesses have become increasingly dependent on a world-wide customer base. The ability to facilitate the international shipment of products to these customers has become an important factor in determining how successful a corporation will be in the global marketplace. An Internet user, who is a potential customer, can be physically located in one country and have access to businesses and products that are physically located all over the world. Therefore, a business that sells products over the Internet must have the ability to ship products to customers located in any country. In addition, it must be able to ship products in an efficient manner in order to retain customers and to remain competitive. Using the address formats that are preferred by the various post offices can help with the delivery process.

Today, typical computer address databases store the various components of an address (e.g., street address, city, province or state, postal code, and country name) in a parsed format. Each address component is stored in a separate database field. It would be advantageous for these individual database elements to be assembled into a shipping label format that could be easily read and interpreted by post offices, parcel services and other freight handlers in the shipping, transit, and destination countries.

Currently, there is no single international standard for shipping labels and therefore, the preferred address formats vary from country to country. The Universal Postal Union (UPU) is a specialized division of the United Nations (UN). The stated mission of the UPU is to promote and develop communication between the people of the world. As part of the leadership role in promoting postal services on an international basis, the UPU publishes the postal address formats associated with each UN member nation. This country specific format is an address format that will be quickly and accurately recognized by distribution or postal personnel in that country. Using the UPU published country specific formats for shipping labels should result in reduced errors and minimal delays.

### SUMMARY OF THE INVENTION

An exemplary embodiment of the present invention is a method for formatting international shipping addresses. The method includes receiving a parsed address from a system user and then looking up the parsed address in an index table. A corresponding address format is retrieved from the index table and then the parsed address is reformatted to comply with the retrieved address format. Additional embodiments include a system and storage medium for formatting international shipping addresses.

### BRIEF DESCRIPTION OF THE DRAWINGS

FIG. 1 is a block diagram of an exemplary system for formatting international shipping addresses.

FIG. 2 depicts a sample address format.

FIG. 3 depicts a sample index table.

FIG. 4 is a flowchart of an exemplary process for formatting international shipping addresses.

FIG. 5 is a flowchart of an exemplary process for applying an address format template to a parsed address.

### DETAILED DESCRIPTION OF THE INVENTION

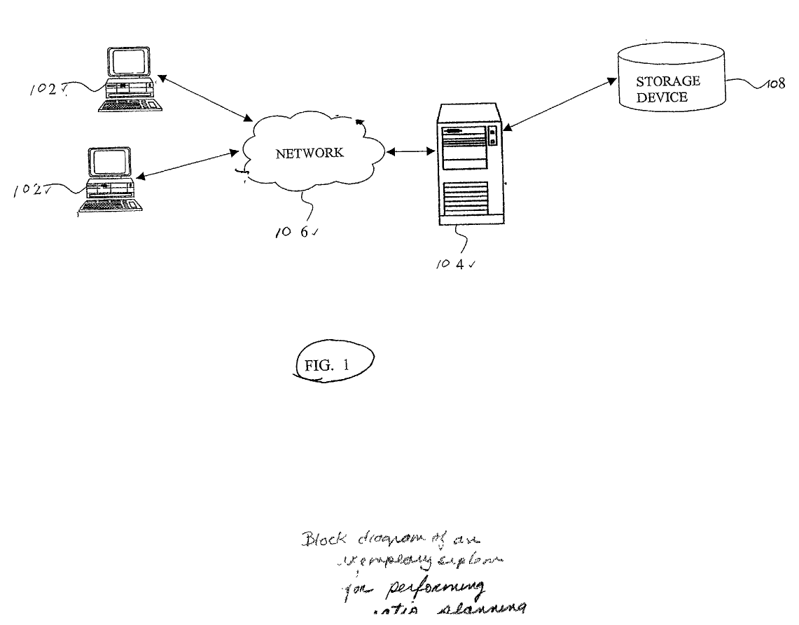

FIG. 1 is a block diagram of an exemplary system for formatting international shipping addresses. The system of FIG. 1 includes user systems 102 through which a user application will request a reformatted address from the host system 104. Additionally, a request for address formatting may come from a computer application running on the host system 104. In a preferred embodiment, the host system 104 executes a program that formats international shipping addresses. The user systems 102 are coupled to a host system 104 via a network 106. Each user system 102 may be implemented using a general-purpose computer executing a computer program for carrying out the processes described herein. The user systems 102 may be personal computers or host attached terminals. If the user systems 102 are personal computers, the processing described herein may be shared by user system 102 and host system 104 by providing an applet to the user system 102.

The network 106 may be any type of known network including a local area network (LAN), a wide area network (WAN), or a global network (e.g., Internet). The user system 102 may be coupled to the host system 104 through multiple networks (e.g., intranet and Internet) so that not all user systems 102 are coupled to the host system 104 through the same network. One or more of the user systems 102 and the host system 104 may be connected to network 106 in a wireless fashion and network 106 may be a wireless network. In a preferred embodiment, network 106 is the Internet and each user system 102 executes a user interface application (e.g., web browser) to contact the host system 104 through the network 106. Alternatively, a user system 102 may be implemented using a device programmed primarily for accessing network 106 such as WebTV.

The host system 104 may be implemented using a server operating in response to a computer program stored in a storage medium accessible by the server. The host system 104 may operate as a network server (often referred to as a web server) to communicate with the user systems 102. The host system 104 handles sending and receiving information to and from user systems 102 and can perform associated tasks. The host system 104 may also include a firewall to prevent unauthorized access to the host system 104 and enforce any limitations on authorized access. For instance, an administrator may have access to the entire system and have authority to modify portions of the system. The firewall may be implemented using conventional hardware and/or software as is known in the art.

The host system 104 also operates as an applications server. The host system 104 executes one or more computer programs to format international shipping addresses. Processing may be shared by the user system 102 and the host system 104 by providing an application (e.g., java applet) to the user system 102. Alternatively, the user system can include a stand-alone software application for performing a portion of the processing described herein. It is understood that separate servers may be used to implement the network server functions and the applications server functions. Alternatively, the network server, firewall and the applications server can be implemented by a single server executing computer programs to perform the requisite functions.

Storage device 108 may be implemented using a variety of devices for storing electronic information such as a file transfer protocol (FTP) server. It is understood that storage device 108 may be implemented using memory contained in host system 104 or may be a separate physical device. Storage device 108 contains a variety of information including the address index table and the address formats. Storage device 108 may also contain information concerning the submission of the address formatting request or the transmittal of address formatting data (e.g. a user identifier, date and time of submission). The host system 104 may also operate as a database server and coordinate access to application data including data stored on storage device 108.

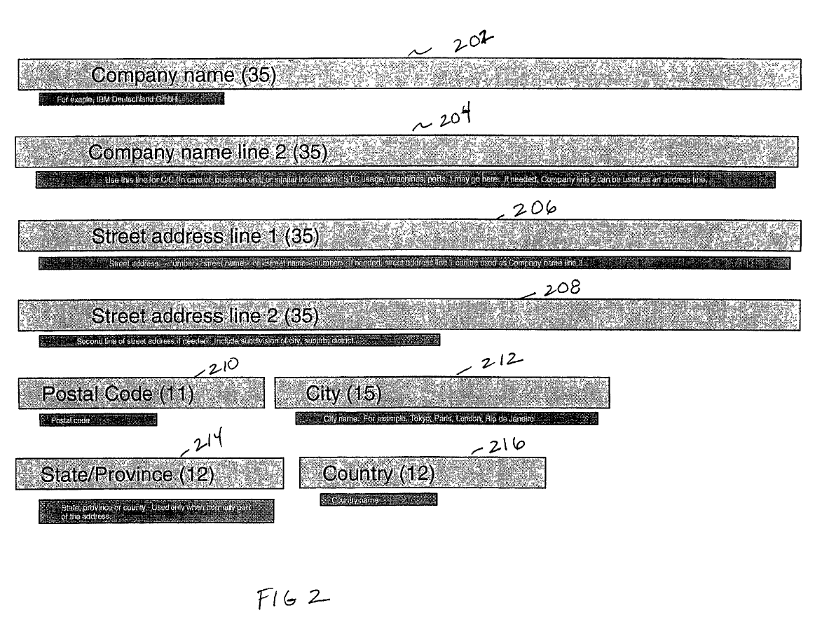

FIG. 2 depicts a sample address format from a standards organization. The format shown is based on the current UPU standards and would currently apply to countries such as Brazil and Poland. Address formatting standards from other standards organizations could also be implemented using the present invention. Referring to FIG. 2, the first and second line contain the company name fields 202 and 204. The third and fourth lines of the address format are the street address fields 206 and 208. The fifth line includes both the postal code field 210 and the city field 212. The last line of this address format contains the state/province field 214 and the country field 216. Each UPU address format can be used by one or more countries, in this example both Brazil and Poland use this format. There will be one address format for each unique address configuration as defined by the UPU. These formats will be updated on a periodic basis, either manually or electronically, based on changes by the UPU. The address formats are stored on a storage device 108 connected to the host system 104.

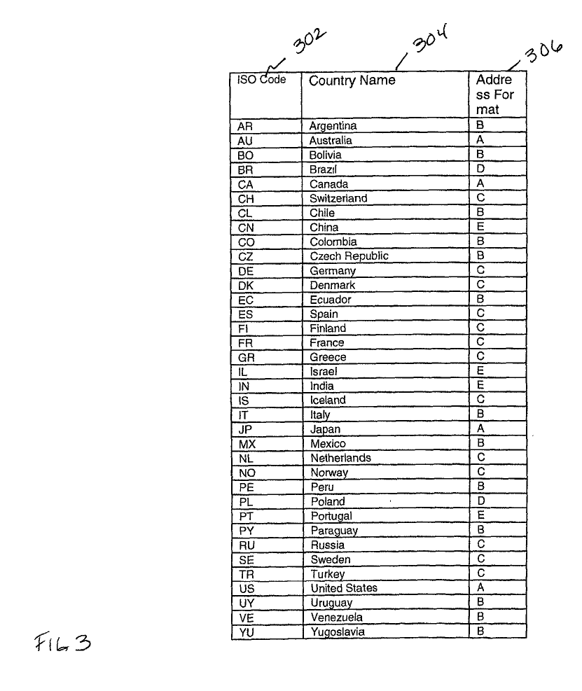

FIG. 3 depicts a sample address index table for an exemplary embodiment. The index table is stored on a storage device 108 that is connected to the host system 104. The index table shows how the address format is tied to each country. The table could include the ISO country code 302, the country name 304, and the address format identifier 306. In this embodiment, the address format identifier 306 ties the country name 304 to a particular address format (see FIG. 2 for an example format). Each UN country is listed in this table along with the associated address format code. The data in this table is updated periodically, either manually or electronically, based on changes made by the UPU to the address formats. In another embodiment, the address format identifer 306 could tie the country code field 302 to a particular address format. In addition, other country codes, from other standards organizations, could be substituted for the ISO country code.

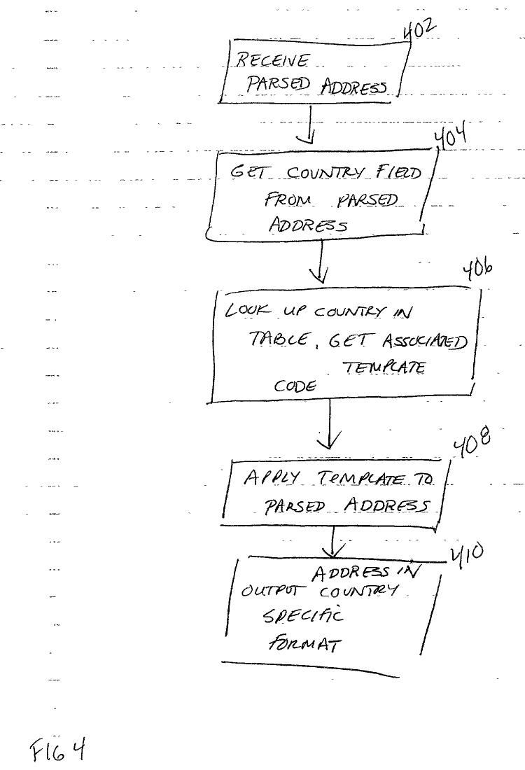

FIG. 4 is a flowchart of an exemplary process for formatting international shipping addresses. A user system 102 will contact the host system 104 through the network 106 to request an address conversion. In addition, this request could come from an application local to the host system 104. The requesting system will send a parsed address to the formatting application. This address will be received by the formatting application at step 402. The application will isolate a portion of the parsed address, in this example the country field at step 414 and look up the country field in the address format table (see FIG. 3) to get the associated address format field at step 406. The application will proceed to apply the template to the parsed address at step 408 and then output the reformatted address in the country specific format at step 410.

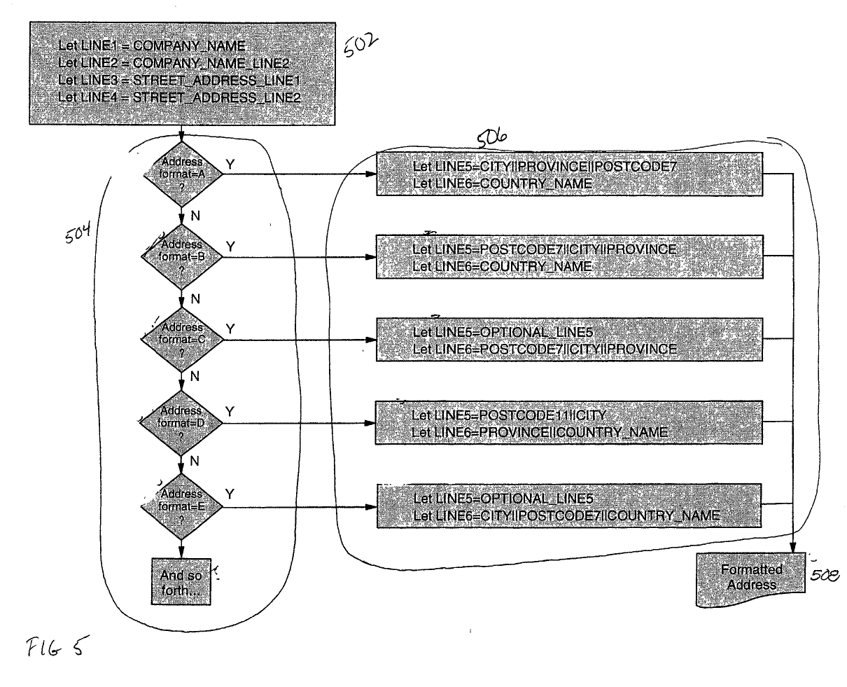

FIG. 5 is a flowchart of an exemplary process for applying an address format template to a parsed address. It shows how the various address lines are assigned values based on the parsed address input. Lines that are common to most address formats are assigned first at step 502. Then, depending on the address format associated with the country code at step 504, other address lines are assigned at step 506. The result is a reformatted address at step 508. The line assignments will be updated on a periodic basis in response to any changes to the address formats or assignments made by the UPU.

As described above, the user system 102 and the host system 104 can share the processing. For example, the user system 102 may include a software application that allows the user system to create a formatting request without assistance from the host system 104. The user system 102 would then contact the host system 104 to generate the report. Alternatively, the host system 104 may provide an application to the user system 102 (e.g., an applet) once the user system 102 contacts the host system 104. Accordingly, processing can be shared by the two systems.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer (such as host system 104) or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

The present invention provides many improvements over the current state of the art of formatting international addresses. In an exemplary embodiment, this invention takes data from a standards organization, such as the UPU, and creates a limited number of country-specific formats to be used in a conversion process against the parsed address data. Using the UPU data as a base for address conversion maintains a degree of international consistency that is recognized by transportation providers worldwide. The conversion application returns a suitable format to be used on labels and documents. In addition, the conversion application can be used to return a suitable format for storage in legacy systems that do not use a parsed form of address-data storage. In addition to supporting a worldwide standard, this conversion application also allows existing data that is stored in parsed format to be reformatting to fit any target country.

An example of a place to apply the present invention is in the business to consumer market. A business could establish a web site for the purpose of taking orders. During the order-taking process the web site could capture the consumer's address information in a parsed format that is consistent with the home country of the business. If the consumer order is from a foreign country, the address label could be converted and printed in the proper format for the destination country. Using the present invention this could be done without negatively impacting either the ordering process or the distribution steps that take place in the origin and transit countries.

Another application of the present invention is at international companies that have numerous legacy databases and computer applications built around the parsed address format discussed above. A method to take the existing data and convert it into the UPU country specific format, without changing the existing databases and computer code would be desirable. In addition, the UPU formats could change over time without necessitating changing the existing databases and computer code. Only the conversion tool would need to be updated with the new formats.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiments for carrying out this invention, but that the invention will include all embodiments falling within the scope of the appended claims.

What is claimed is:

1. A method for formatting international shipping addresses, the method comprising:
receiving a parsed address from a user system;
retrieving a corresponding address format by looking up a portion of said parsed address in an index table; and
generating a formatted shipping address by converting said parsed address into said address format.

2. The method of claim 1 wherein said parsed address includes a country name field; and said retrieving a corresponding address format by looking up a portion of said parsed address in an index table comprises looking up said country name field in said index table.

3. The method of claim1 wherein said parsed address includes a country code field; and said retrieving a corresponding address format by looking up a portion of said parsed address in an index table comprises looking up said country code field in said index table.

4. The method of claim 1 wherein said index table contains at least one entry, each entry comprising a country name and the address format, said address format assigned based on standards from a standards organization.

5. The method of claim 4 wherein said each entry of said index table further comprises a country code.

6. The method of claim 1 wherein said index table contains at least one entry, each entry comprising a country code and the address format, said address format assigned based on standards from a standards organization.

7. The method of claim 1 wherein said index table is manually updated on a periodic basis; said updating in response to changes to said standards from said standards organization.

8. The method of claim 1 wherein said index table is automatically updated on a periodic basis; said updating in response to changes in said standards from said standards organization.

9. The method of claim 1 wherein said index table contains at least one entry, each entry comprising a country name and an address format identifier, said address format identifier corresponding to said address format.

10. The method of claim 9 wherein said index table further comprises a country code.

11. The method of claim 1 wherein said index table contains at least one entry, each entry comprising a country name and an address format identifier, said address format identifier corresponding to said address format.

12. A system for formatting international shipping addresses, the system comprising:
a storage device storing an index table; and
a host system in communication with said storage device, said host system implementing a process comprising:
receiving a parsed address from a user system;
retrieving a corresponding address format by looking up a portion of said parsed address in an index table; and
generating a formatted shipping address by converting said parsed address into said address format.

13. The system of claim 12 wherein said parsed address includes a country name field; and said retrieving a corresponding address format by looking up a portion of said parsed address in an index table comprises looking up said country name field in said index table.

14. The system of claim12 wherein said parsed address includes a country code field; and said retrieving a corresponding address format by looking up a portion of said parsed address in an index table comprises looking up said country code field in said index table.

15. The system of claim 12 wherein said index table contains at least one entry, each entry comprising a country name and the address format, said address format assigned based on standards from a standards organization.

16. The system of claim 15 wherein said each entry of said index table further comprises a country code.

17. The system of claim 12 wherein said index table contains at least one entry, each entry comprising a country code and the address format, said address format assigned based on standards from a standards organization.

18. The system of claim 12 wherein said index table is manually updated on a periodic basis; said updating in response to changes to said standards from said standards organization.

19. The system of claim 12 wherein said index table is automatically updated on a periodic basis; said updating in response to changes in said standards from said standards organization.

20. The system of claim 12 wherein said index table contains at least one entry, each entry comprising a country name and an address format identifier, said address format identifier corresponding to said address format.

21. The system of claim 20 wherein said index table further comprises a country code.

22. The system of claim 12 wherein said index table contains at least one entry, each entry comprising a country name and an address format identifier, said address format identifier corresponding to said address format.

23. The system of claim 12 further comprising a network providing communication between the host system and the user system.

24. The system of claim 23 wherein said network is an internet, an intranet, a LAN or a WAN.

25. The system of claim 12 further comprising a network providing communication between the storage device and the host system.

26. A system for formatting international shipping addresses in a communications network environment, comprising:
a host system including a web server, an applications server, and a database server;
at least one data storage device in communication with said host system;
international shipping addresses formatting software application being executed by said host system;
a firewall in communication with said host system;
a user system;
a computer network connecting the host system to the user system; wherein information inputted into the user system is transferred to the host system and made available to the international shipping address formatting software application.

27. The system of claim 26 wherein said international shipping address formatting software application is being executed by said user system.

28. A storage medium encoded with machine-readable computer program code for formatting international shipping addresses, the storage medium storing instructions for causing a host system to implement a method comprising:
receiving a parsed address from a user system;
retrieving a corresponding address format by looking up a portion of said parsed address in an index table; and
generating a formatted shipping address by converting said parsed address into said address format.

29. The storage medium of claim 28 wherein said parsed address includes a country name field; and said retrieving a corresponding address format by looking up a portion of said parsed address in an index table comprises looking up said country name field in said index table.

30. The storage medium of claim28 wherein said parsed address includes a country code field; and said retrieving a corresponding address format by looking up a portion of said parsed address in an index table comprises looking up said country code field in said index table.

31. The storage medium of claim 28 wherein said index table contains at least one entry, each entry comprising a country name and the address format, said address format assigned based on standards from a standards organization.

32. The storage medium of claim 31 wherein said each entry of said index table further comprises a country code.

33. The storage medium of claim 28 wherein said index table contains at least one entry, each entry comprising a country code and the address format, said address format assigned based on standards from a standards organization.

34. The storage medium of claim 28 wherein said index table is manually updated on a periodic basis; said updating in response to changes to said standards from said standards organization.

35. The storage medium of claim 28 wherein said index table is automatically updated on a periodic basis; said updating in response to changes in said standards from said standards organization.

36. The storage medium of claim 28 wherein said index table contains at least one entry, each entry comprising a country name and an address format identifier, said address format identifier corresponding to said address format.

37. The storage medium of claim 36 wherein said index table further comprises a country code.

38. The storage medium of claim 28 wherein said index table contains at least one entry, each entry comprising a country name and an address format identifier, said address format identifier corresponding to said address format.
